(19) United States
(12) Patent Application Publication
(10) Pub. No.: US 2003/0096583 A1
(43) Pub. Date: May 22, 2003

(54) Mobile radio apparatus

(75) Inventor: Hiroshi Watanabe, Hachioji-shi (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/298,064

(22) Filed: Nov. 18, 2002

(30) Foreign Application Priority Data
Nov. 20, 2001 (JP) 2001-355101

(51) Int. Cl. H04B 1/38

(52) U.S. Cl. 455/90; 455/344; 455/280

(57) ABSTRACT

In a mobile radio apparatus, a matching circuit is selected to meet the detected condition detected by a switching control unit. Matching of the antenna to the RF circuit can be optimized and the antenna gain deterioration can be prevented.

### CROSS-REFERENCE TO RELATED APPLICATIONS

This application is based upon and claims the benefit of priority from the prior Japanese Patent Application No. 2001-355101, filed Nov. 20, 2001, the entire contents of which are incorporated herein by reference.

### BACKGROUND OF THE INVENTION

1. Field of the Invention

The present invention relates to a mobile radio apparatus.

2. Description of the Related Art

A mobile radio apparatus having first and second units has been known. In a conventional mobile radio apparatus of this type, when matching an antenna 101 to other circuits regardless of whether a first unit 118 and a second unit 119 are slid with each other or not or opened or closed as shown in FIGS. 15A, 15B, 15C, one matching circuit 130 as shown in FIG. 17 or a set of constants as shown in FIG. 18 (numeric values realized by impedance matching elements 131-133, a coil L or a capacitor C) has been used for matching.

In this conventional mobile radio apparatus, when matching an antenna 101 to other circuits (e.g., RF circuit) on the assumption that the units are not slid or closed (refer to the graph of FIG. 19A), the antenna 101 comes close to the first unit 118 on matching the antenna 101 to other circuits with the units slid or opened, the impedance of the antenna 101 varies largely as shown in the graph of FIG. 19B, matching of the antenna 101 to other circuits fails, causing a mismatching loss, and the antenna gain is extremely deteriorated.

On the other hand, when matching the antenna 101 to other circuits on the assumption that the units are slid or opened (refer to the graph of FIG. 19A), the antenna 101 is not influenced by the first unit 118 on matching the antenna 101 to other circuits with the units not slid or closed, the impedance of the antenna 101 varies largely as shown in the graph of FIG. 19C, matching of the antenna 101 to other circuits fails, causing a mismatching loss, and the antenna gain is extremely deteriorated.

Further, when matching the antenna 101 and other circuits to the intermediate impedance between the values obtained when matching the antenna 101 to other circuits with the units slid or opened and when matching the antenna 101 to other circuits with the units not slid or closed;

the antenna 101 is not completely matched to other circuits (refer to the graph of FIG. 19D), causing a mismatching loss, and the antenna gain is extremely deteriorated compared to the matching shown in the graph of FIG. 9A.

In the above description, the condition of the antenna 101 (extended or contracted) are not considered. Description will now be given on the case when the conditions of the antenna 101 are taken into consideration.

In a conventional mobile radio apparatus of this type, one matching circuit 130 as shown in FIG. 17 or a set of constants as shown in FIG. 18 (numeric values realized by impedance matching elements 131-133, a coil L or a capacitor C) has been used for matching, regardless of whether the antenna 101 is extended (refer to FIGS. 16A, 16B, 16C) or contracted (refer to FIGS. 15A, 15B, 15C) and whether the first unit 118 and the second unit 119 are slid (opened) or not slid (closed).

In this conventional mobile radio apparatus, when matching the antenna 101 to other circuits on the assumption that antenna 101 is extended or contracted and the units are not slid or closed (refer to the graph of FIG. 19A), the antenna 101 comes close to the first unit 118 on matching the antenna 101 to other circuits with the units slid or opened, the impedance of the antenna 101 varies largely as shown in the graph of FIG. 19B, matching of the antenna 101 to other circuits fails, causing a mismatching loss, and the antenna gain is extremely deteriorated. Further, when the antenna 101 is set to the condition reverse to the above matching condition, the influence upon the antenna 101 from the units is different when the antenna 101 is extended and contracted, causing a more mismatching loss, and the antenna gain is extremely deteriorated.

On the other hand, when matching the antenna 101 to other circuits on the assumption that the antenna 101 is extended or contracted and the units are in being slid or opened (refer to the graph of FIG. 19A), the antenna 101 is not influenced by the first unit 118 on matching the antenna 101 to other circuits with the units not slid or closed, the impedance of the antenna 101 varies largely as shown in the graph of FIG. 19C, matching of the antenna 101 to other circuits fails, causing a mismatching loss, and the antenna gain is extremely deteriorated. Further, when the antenna 101 is set to the condition reverse to the above matching condition, the influence upon the antenna 101 from the units is different when the antenna 101 is extended and contracted, causing a more mismatching loss, and the antenna gain is extremely deteriorated.

Further, when matching the antenna 101 and other circuits to the intermediate impedance between the values obtained when matching the antenna 101 to other circuits with the antenna 101 extended and the units slid or opened and when matching the antenna 101 to other circuits with the antenna 101 contracted and the units slid or opened, and between the values obtained when matching the antenna 101 to other circuits with the antenna 101 extended and the units not slid or closed and when matching the antenna 101 to other circuits with the antenna 101 contracted and the units not slid or closed; the antenna 101 is not completely matched to other circuits (refer to the graph of FIG. 19D), causing a mismatching loss, and the antenna gain is extremely deteriorated compared to the matching shown in the graph of FIG. 19A.

As described above, in a conventional mobile radio apparatus, when an antenna 101 is constructed to be extended when it is housed in the apparatus and when the apparatus is used with the units slid/not slid or opened/closed, the impedance of the antenna 101 varies, and as only one matching circuit is provided between the antenna 101 and other circuits (e.g., RF circuit) and only one set of constants is used, a mismatching loss of impedance occurs between the antenna 101 and other circuits.

The present invention has been made to solve the above-mentioned problems. Accordingly, it is an object of the present invention is to provide a mobile radio apparatus capable of matching the impedances of an antenna and other circuits even if antenna impedance varies depending on changes in the conditions of first and second units.

It is another object of the present invention is to provide a mobile radio apparatus capable of matching the impedances of an antenna and other circuits even if an antenna impedance varies depending on changes in the conditions of first and second units and changes in the conditions of antenna.

### BRIEF SUMMARY OF THE INVENTION

The present invention has the following aspects to solve the above-mentioned problems and achieve the object.

According to a first aspect of the present invention, there is provided a mobile radio apparatus comprising: a first case unit, a second case unit, each of unit changes its position; an antenna provided in the first case unit or case second unit; a case condition detecting unit configured to detect a condition between the first case unit and second case unit; matching unit configured to match between the antenna and a circuit; and a switching unit configured to connect the matching unit to the antenna and other circuits based on the detected condition.

According to a second aspect of the present invention, there is provided a mobile radio apparatus according to the first aspect, wherein the first and second case units are slidable with each other.

According to a third aspect of the present invention, there is provided a mobile ratio apparatus according to the first aspect, wherein the first and second case units are constructed foldable.

According to a fourth aspect of the present invention, there is provided a mobile radio apparatus according to the first aspect, an antenna condition detecting unit configured to detecting a condition of the antenna in the apparatus, wherein the switching unit connects one of the matching unit to the antenna and the circuit based on the detected conditions of the case condition and antenna condition.

According to a fifth aspect of the present invention, there is provided a mobile radio apparatus according to the first aspect, wherein the switching unit includes a switch.

According to a sixth aspect of the present invention, there is provided a mobile radio apparatus according to the first aspect, wherein the switch is an element whose capacity is changed by application of voltage.

According to a seventh aspect of the present invention, there is provided a mobile radio apparatus according to the sixth aspect, wherein which further includes a storage unit for storing information about the voltage applied to the element.

According to an eighth aspect of the present invention, there is provided a mobile radio apparatus according to the first to seventh aspect, wherein the antenna has two or more resonance frequencies.

According to a ninth aspect of the present invention, there is provided a mobile radio apparatus which comprises a first case unit, a second case unit, each of unit changes its position; an antenna provided in the first case unit or case second unit; a case condition detecting unit configured to detect a condition between the first case unit and second case unit; a matching unit connected to the antenna, capable of matching two or more impedances; and a setting unit configured to set an impedance of the matching unit to one value based on the detected condition.

Additional objects and advantages of the invention will be set forth in the description which follows, and in part will be obvious from the description, or may be learned by practice of the invention. The objects and advantages of the invention may be realized and obtained by section of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing the configuration of a first embodiment of the present invention;

FIG. 2 is a table showing the conditions of the switches according to the conditions of the units in the first embodiment;

FIG. 3A is a schematic view showing the non-slid or closed condition of the units in the first embodiment;

FIG. 3B is a schematic view showing the slid condition of the units in the first embodiment;

FIG. 3C is a schematic view showing the opened condition of the units in the first embodiment;

FIG. 4 is a block diagram showing the configuration of a second embodiment of the present invention;

FIG. 5 is a table showing the conditions of the switches according to the conditions of the units in the second embodiment;

FIGS. 6A and 6B are block diagrams of two matching circuits configured according to switching of the switches shown in FIG. 4;

FIG. 7 is a block diagram showing the configuration of a third embodiment of the present invention;

FIG. 8 is a block diagram showing the detailed configuration of the matching circuit 10 shown in FIG. 7;

FIG. 9 is a block diagram showing the configuration of a fourth embodiment of the present invention;

FIG. 10 is a block diagram showing the detailed configuration of the matching circuit 54 shown in FIG. 9;

FIG. 11A is a schematic view showing the non-slid or closed condition of the units with the antenna contracted in the fourth embodiment;

FIG. 11B is a schematic view showing the slid condition of the units with the antenna contracted in the fourth embodiment;

FIG. 11C is a schematic view showing the opened condition of the units with the antenna contracted in the fourth embodiment;

FIG. 12A is a schematic view showing the non-slid or closed condition of the units with the antenna extended in the fourth embodiment;

FIG. 12B is a schematic view showing the slid condition of the units with the antenna extended in the fourth embodiment;

FIG. 12C is a schematic view showing the opened condition of the units with the antenna extended in the fourth embodiment;

FIG. 13 is a block diagram showing the configuration of a fifth embodiment of the present invention;

FIG. 14 is a block diagram showing the detailed configuration of the matching circuit 61 shown in FIG. 13;

FIG. 15A is a schematic view showing the non-slid or closed condition of the units with the antenna contracted in a conventional example;

FIG. 15B is a schematic view showing the slid condition of the units with the antenna contracted in a conventional example;

FIG. 15C is a schematic view showing the opened condition of the units with the antenna contracted in a conventional example;

FIG. 16A is a schematic view showing the non-slid or closed condition of the units with the antenna extended in a conventional example;

FIG. 16B is a schematic view showing the slid condition of the units with the antenna extended in a conventional example;

FIG. 16C is a schematic view showing the opened condition of the units with the antenna extended in a conventional example;

FIG. 17 is a block diagram showing the configuration of a conventional example;

FIG. 18 is a block diagram showing an example of a conventional matching circuit;

FIG. 19A is a graph showing the condition that the impedances of the antenna and other circuits are matched;

FIG. 19B is a graph showing the condition of matching in the slid or opened condition when the impedances of the antenna and other circuits are matched in the non-slid or closed condition;

FIG. 19C is a graph showing the condition of matching in the non-slid or closed condition when the impedances of the antenna and other circuits are matched in the slid or opened condition; and

FIG. 19D is a graph showing that impedances of the antenna and other circuits are matched to the intermediate impedance between when the impedances of the antenna and other circuits are matched in the slid or opened condition, and when the impedances of the antenna and other circuits are matched in the non-slid or closed condition.

### DETAILED DESCRIPTION OF THE INVENTION

First, the essentials common to the embodiments of the present invention will be explained.

A mobile radio apparatus of the present invention comprising first and second units detects the slid/non-slid with each other or opened/closed conditions of the units and changes constants or matching sections, such as matching circuits disposed between an antenna and other circuits.

In this mobile radio apparatus, optimum matching may be used for detecting slid/non-slid or opened/closed conditions, and deterioration of the antenna gain due to mismatching can be prevented.

The mobile radio apparatus of the present invention also enables optimum matching for slid/non-slid or opened/closed conditions of the units with the antenna extended or contracted, and prevents deterioration of the antenna gain due to mismatching.

Hereinafter preferred embodiments of the present invention will be explained with reference to the accompanying drawings.

(Embodiment 1)

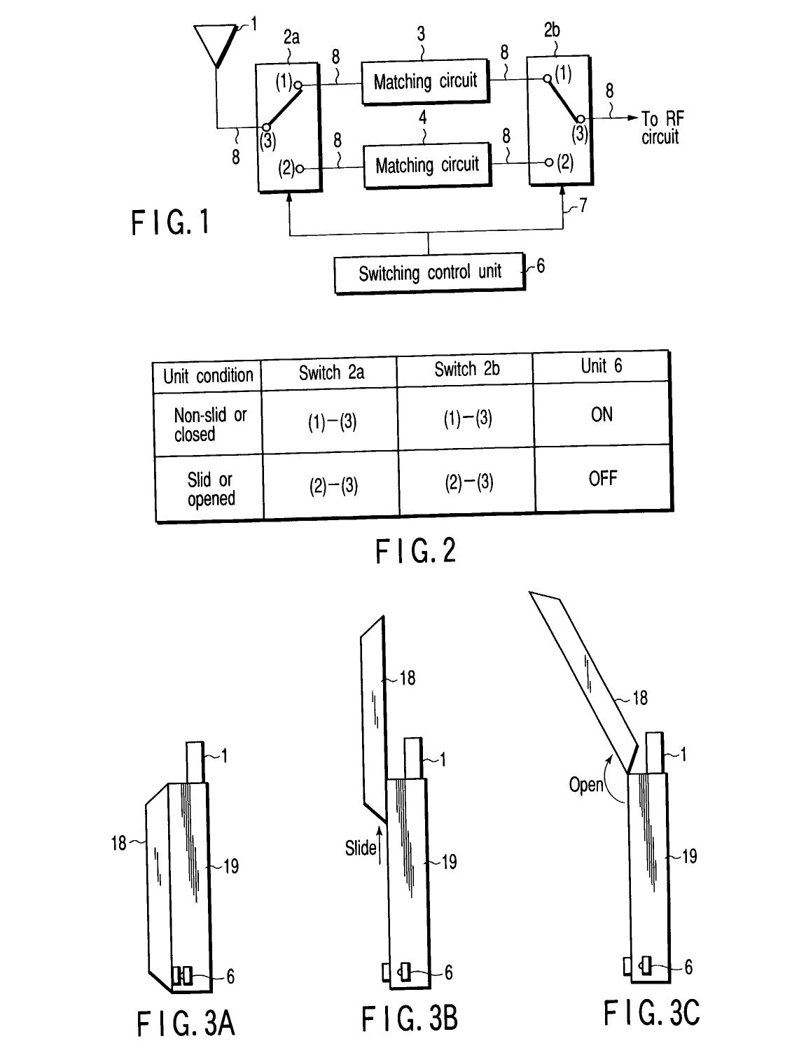

FIG. 1 is a block diagram showing the configuration of a mobile radio apparatus according to a first embodiment of the present invention. In FIG. 1, a reference numeral 1 means an antenna, 2a/2b mean circuit changing switches, 3 means a matching circuit used when the units are not slid or closed, 4 means a matching circuit used when the units are slid or opened, 6 means a switching control unit for detecting the condition of the first unit and the second unit and switching the switch 2a or the switch 2b based on the detected condition. 7 means a control line to transmit the conditions of the units detected by the switching control unit 6, and 8 means a RF signal line.

In the configuration comprising the above components, the condition of the units detected by the switching control unit 6 is transmitted to the circuit changing switches 2a/2b through the control line 7, and the matching circuit is changed over according to the detected condition. In this case, a table as shown in FIG. 2 is to be referenced. For example, when the detected condition is not slid or closed (the switching control unit 6 is ON at this time), the circuit changing switches 2a/2b are connected to the side (1) and the matching circuit 3 is selected. When the detected condition is slid or opened (the switching control unit 6 is OFF at this time), the circuit changing switches 2a/2b are connected to the side (2) and the matching circuit 4 is selected.

FIG. 3A shows the non-slid or closed condition of the units of a mobile radio apparatus of this embodiment. The switching control unit 6 is ON at this time. A reference numeral 18 means a first unit, and 19 means a second unit.

FIG. 3B shows the slid condition of the units of a mobile radio apparatus of this embodiment. The switching control unit 6 is OFF at this time.

FIG. 3C shows the opened condition of the units of a mobile radio apparatus of this embodiment. The switching control unit 6 is OFF at this time.

According to the mobile radio apparatus of the above-mentioned first embodiment, a matching circuit is selected to meet the conditions of the units detected, matching of the antenna to the RF circuit can be optimized and the antenna gain deterioration can be prevented.

(Embodiment 2)

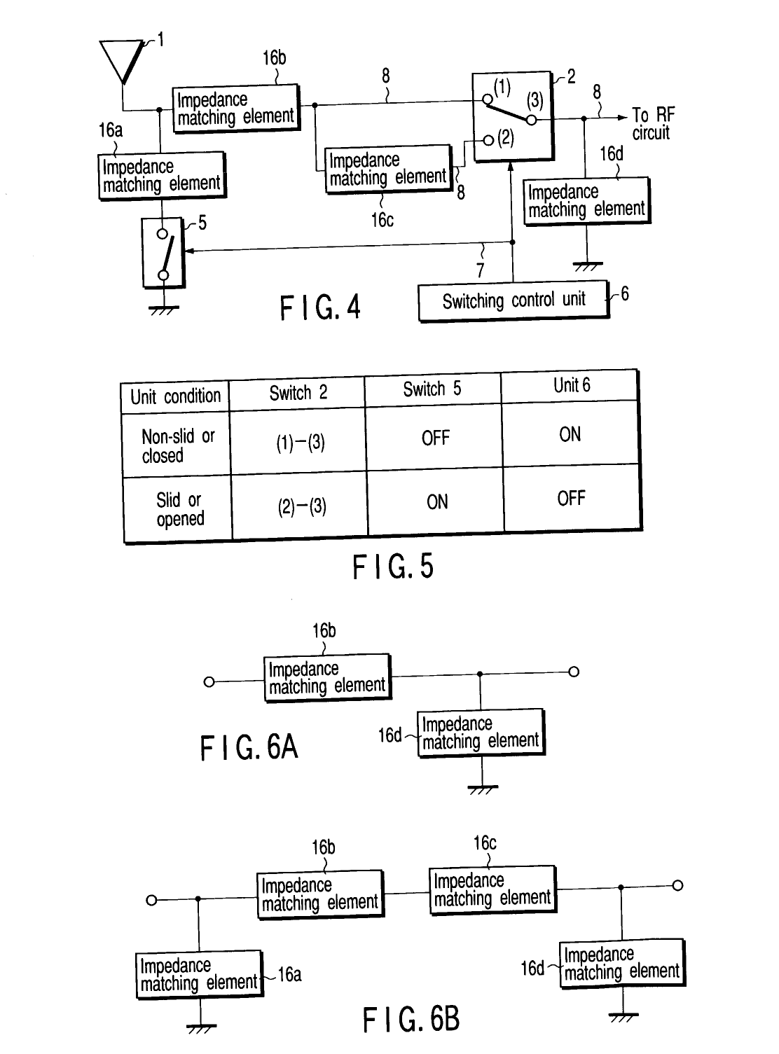

FIG. 4 shows the configuration of a mobile radio apparatus according to a second embodiment of the present invention. In FIG. 4, a reference numeral 1 means an antenna, 2/5 mean circuit changing switches, 7 means a control line to transmit the conditions of the units, 8 means a RF signal line, and 16a-16d mean impedance matching elements, a coil L or a capacitor C. 6 means a switching control unit for detecting the condition of the first unit and the second unit and switching the switch 2 or the switch 5 based on the detected condition

In the configuration comprising the above components, the detected condition of the units detected by the switching control unit 6 is transmitted to the circuit changing switches 2/5 through the control line 7, and the matching circuit is changed over according to the detected condition. In this case, a table as shown in FIG. 5 is to be referenced. For example, when the detected condition is not slid or closed (the switching control unit 6 is ON at this time), the circuit changing switch 2 is connected to the side (1) and the switch 5 forms a matching circuit where the switch is OFF (refer to FIG. 6A), realizing optimum matching when the detected condition is not slid or closed.

When the detected condition is slid or opened (the switching control unit 6 is OFF at this time), the circuit changing switch 2 is connected to the side (2) and the switch 5 forms a matching circuit where the switch is ON (refer to FIG. 6B), realizing optimum matching when the detected condition is slid or opened.

According to the mobile radio apparatus of the above-mentioned second embodiment, a matching circuit is selected to meet the detected condition of the units, matching of the antenna to the RF circuit can be optimized and the antenna gain deterioration can be prevented. Further, it is possible to reduce the number of elements required by the matching circuits which are changed over depending on whether the units are opened or closed.

(Third Embodiment)

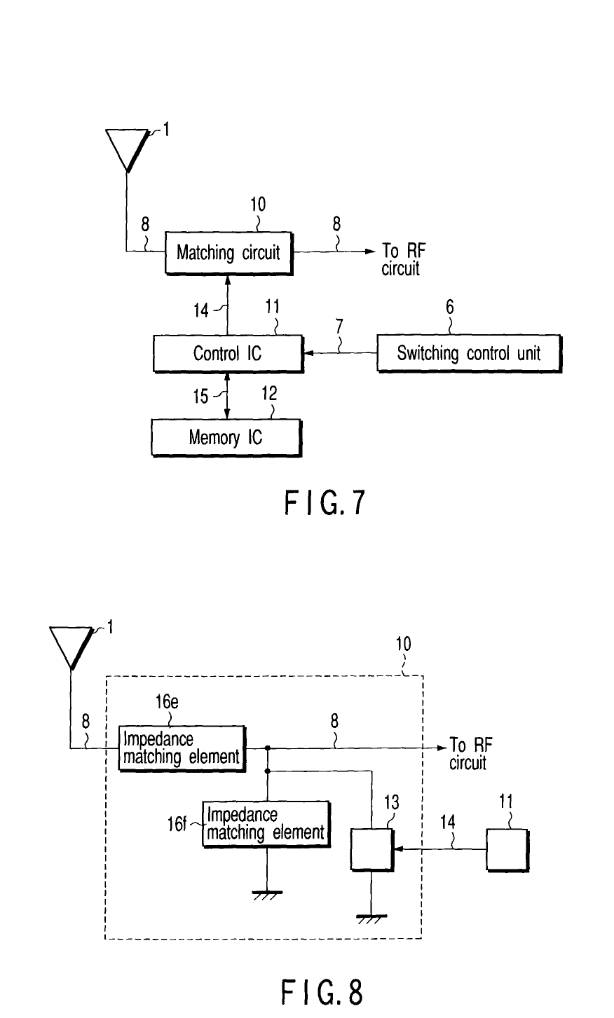

FIG. 7 shows the configuration of a mobile radio apparatus according to a third embodiment of the present invention. In FIG. 7, a reference numeral 1 means an antenna, 10 means a matching circuit provided between the antenna 1 and a RF circuit, 6 means a switching control unit, 7 means a control line to transmit the unit conditions judged by the switching control unit 6, 8 means a RF signal line, 11 means a control IC for controlling a matching circuit 10 based on the information transmitted from the control line 7, 12 means a memory IC to store the information according to the unit conditions, 14 means a control line provided between the control IC 11 and the matching circuit 10, and 15 means a bus line connecting the control IC 11 and memory IC 12.

FIG. 8 shows the details of the matching circuit 10 explained in FIG. 7. The matching circuit 10 comprises two impedance matching elements 16e/16f each of which comprises a coil L or a capacitor C, and a means (section) 13 for changing a capacitive component by a voltage.

In the configuration comprising the above components, the unit condition detected by the switching control unit 6 are transmitted to the control IC 11 through the control line 7, the control IC 11 reads from the memory IC 12 the voltage information corresponding to the detected condition at that time, and sends the voltage information to the matching circuit 10 through the control line 14. In the matching circuit 10, the voltage information is applied to the means (section) 13 for changing a capacitive component by a voltage, and the means (section) 13 changes the capacity to the level according to the applied voltage information. Thus, the matching circuit 10 becomes a matching circuit suitable to the detected condition.

According to the mobile radio apparatus of the above-mentioned third embodiment, a matching circuit is selected to meet the detected condition, matching of the antenna to the RF circuit can be optimized and the antenna gain deterioration can be prevented. Further, as the impedance elements required by the matching circuits are shared by the two matching circuits, the number of parts can be reduced.

(Fourth Embodiment)

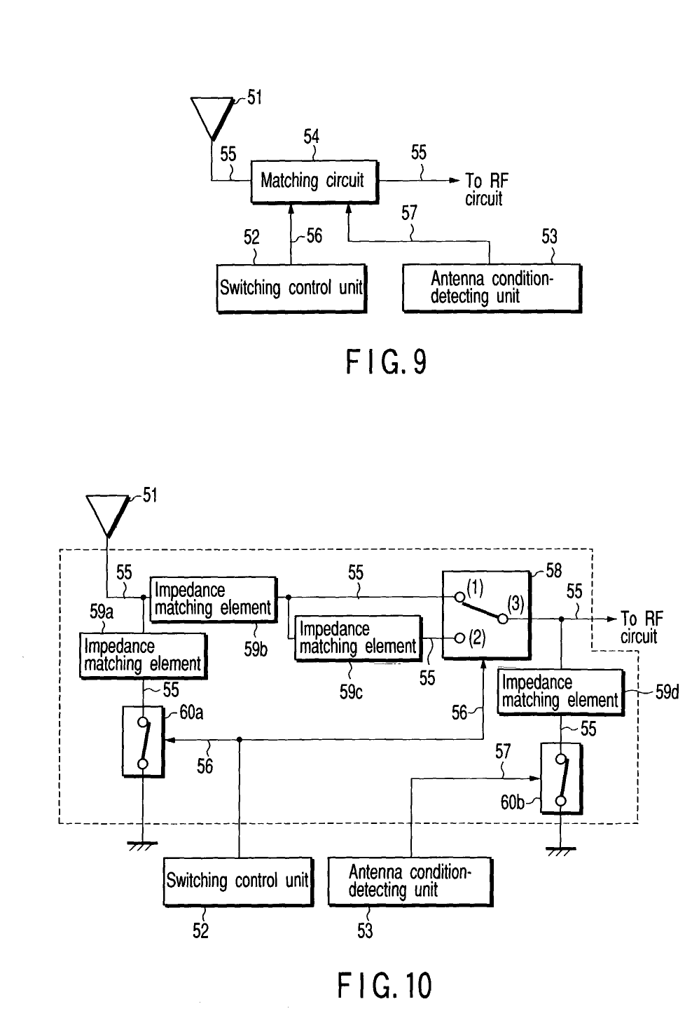

FIG. 9 shows the configuration of a mobile radio apparatus according to a fourth embodiment of the present invention. In FIG. 9, a reference numeral 51 is means an antenna, 52 means a switching control unit to judge the conditions of the units, 53 means an antenna condition-detecting unit for detecting a condition of the antenna 51 and switching a switch based on the detected condition. The detected condition may be expanded or contracted, 55 means a RF signal line, 56 means a control line to transmit the conditions of the units detected by the switching control unit condition, and 57 means a control line to transmit the detected condition of the antenna.

FIG. 10 shows the details of the matching circuit 54 explained in FIG. 9. In FIG. 10, reference numerals 58, 60a and 60b mean circuit changing switches, and 59a-59d mean impedance matching elements, a coil L or a capacitor C.

In the mobile radio apparatus of the above configuration, the detected condition detected by switching control unit 52 is transmitted to the circuit changing switches 60a/58 through the control line 56, and the circuit changing switches 60a/58 are changed over. The antenna condition detected by the antenna condition-detecting unit 53 is transmitted to the circuit changing switch 60b of the matching circuit 54 through the control line 57, and the switch 60b is selected. Thus, optimum matching is realized according to the detected condition of the antenna and the detected condition of the units.

The results of judgment by the switching control unit 52 can be applied to optional combination of the circuit changing switches 58, 60a and 60b. The results of judgment by the antenna condition-detecting unit 53 can also be applied in the same way.

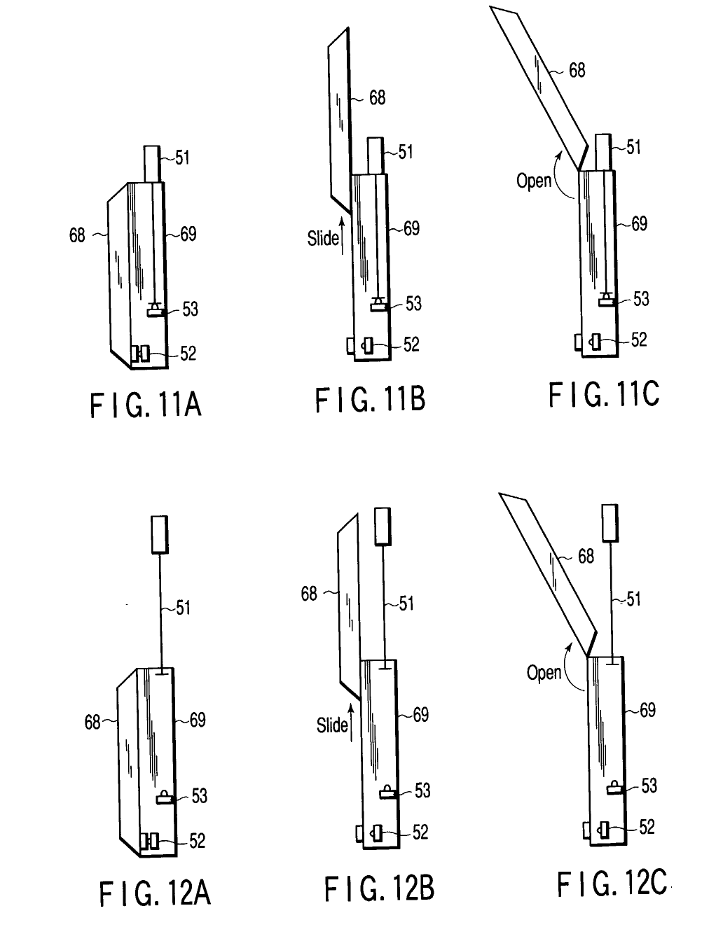

FIG. 11A shows the non-slid or closed condition of the units with the antenna contracted in the fourth embodiment. The switching control unit 52 is ON, and the antenna condition-detecting unit 53 is ON. Reference numeral 68 means a first unit, and 69 means a second unit.

FIGS. 11B and 11C show the slid or opened condition of the units with the antenna contracted in the fourth embodiment. The switching control unit 52 is OFF, and the antenna condition-detecting unit 53 is ON.

FIG. 12A shows the non-slid or closed condition of the units with the antenna extended in the fourth embodiment. The switching control unit 52 is ON, and the antenna condition-detecting unit 53 is OFF.

FIGS. 12B and 12C show the slid and opened conditions of the units with the antenna extended in the fourth embodiment. The switching control unit 52 is OFF, and the antenna condition-detecting unit 53 is OFF.

According to the mobile radio apparatus of the above-mentioned fourth embodiment, a matching circuit is selected to meet the conditions of the antenna and the units, matching of the antenna to the RF circuit can be optimized according to the conditions of the antenna and the units, and the antenna gain deterioration can be prevented.

(Embodiment 5)

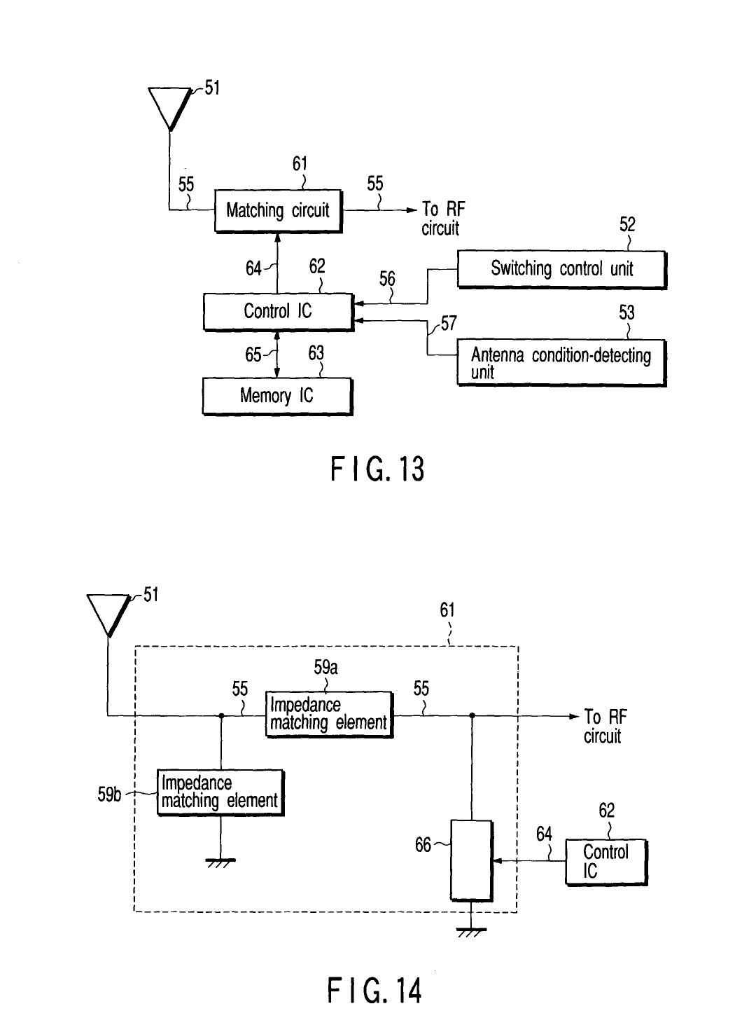

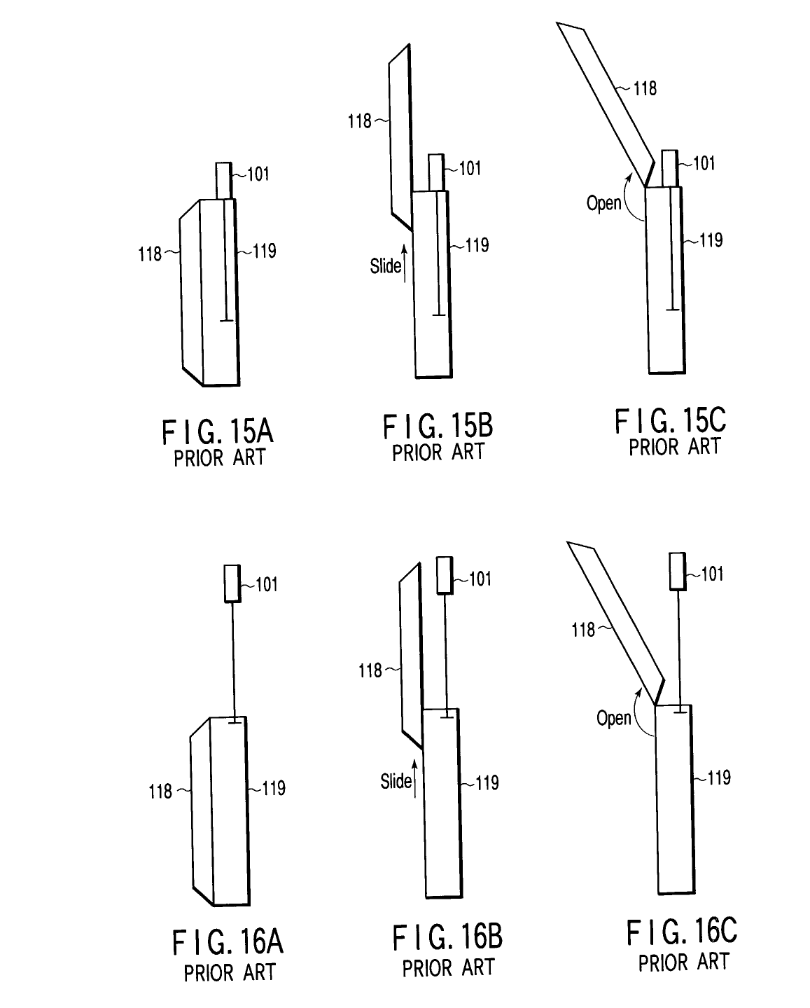

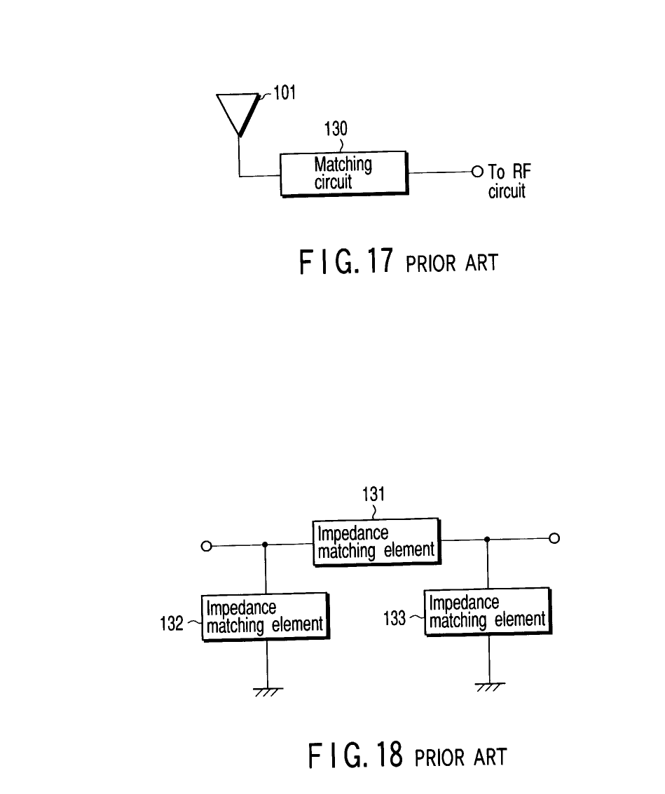

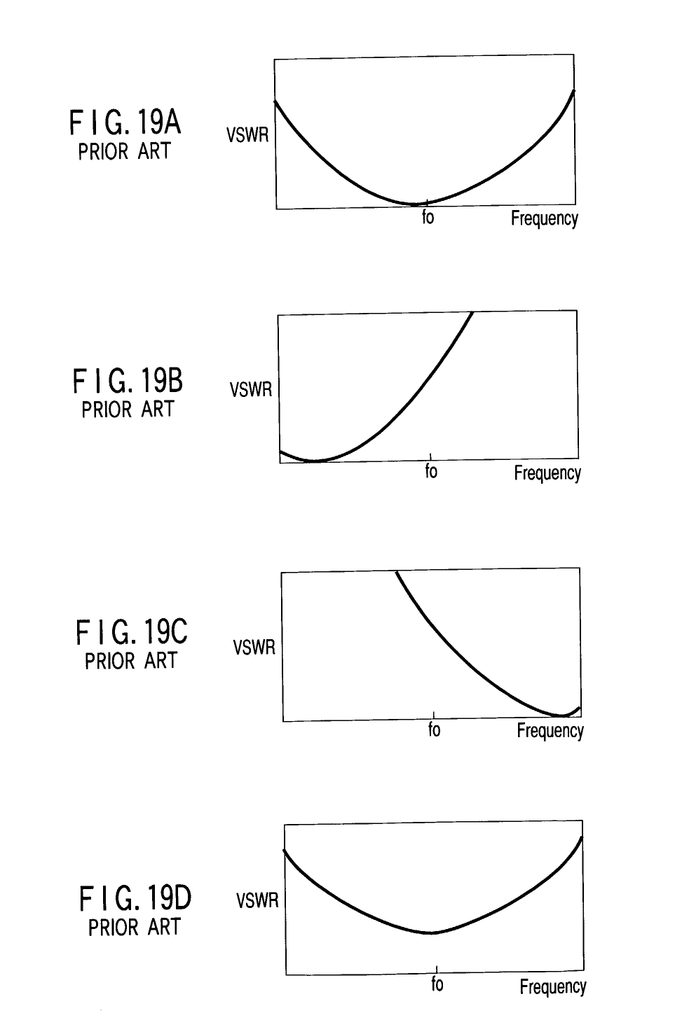

FIG. 13 shows the configuration of a mobile radio apparatus according to a fifth embodiment of the present invention. In FIG. 13, a reference numeral 51 means an antenna, 52 means a switching control unit to judge the conditions of the units, 53 means an antenna condition-detecting unit for detecting a condition of the antenna 51 and switching a switch based on the detected condition. The detected condition may be expanded or contracted, 55 means a RF signal line, 56 means a control line to transmit the conditions of the units detected by the switching control unit condition judging switch, and 57 means a control line to transmit the detected condition of the antenna, 61 means a matching circuit provided between the antenna 51 and RF circuit, 62 means a control IC for controlling the matching circuits based on the information transmitted from the control lines 56/57, 63 means a memory IC to store the information according to the unit conditions, 64 means a control line provided between the control IC 62 and the matching circuit 61, and 65 means a bus line connecting the control IC 62 and memory IC 63.

FIG. 14 shows the details of the matching circuit 61 explained in FIG. 13. The matching circuit 61 comprises two impedance matching elements 59a/59b each of which comprises a coil L or a capacitor C, and a means (section) 66 for changing a capacitive component by a voltage.

In the configuration comprising the above components, the unit condition detected by the switching control unit 52 are transmitted to the control IC 62 through the control line 56. Likewise, the antenna condition-detecting judged by the antenna condition detecting unit 53 are transmitted to the control IC 62 through the control line 57. The control IC 62, as a setting means, reads from the memory IC 63 the voltage information corresponding to the inputted conditions of the antenna and the units, and sends the voltage information to the matching circuit 61 through the control line 64. In the matching circuit 61, the voltage information is applied to the means (section) 66 for changing a capacitive component by a voltage, and the means (section) 66 changes the capacity to the level according to the applied voltage information. Thus, the matching circuit 61 becomes a matching circuit suitable to the antenna conditions and unit conditions.

According to the mobile radio apparatus of the above-mentioned fifth embodiment, a matching circuit is selected to meet the conditions of the antenna and the units, matching of the antenna to the RF circuit can be optimized according to the conditions of the antenna and the units, and the antenna gain deterioration can be prevented.

(Modification)

The present invention can also be modified as described hereinafter.

Since the mobile radio apparatus illustrated in each above-mentioned embodiment is so constructed that the antenna 101 is extended and contracted, the influence from the units to the antenna 101 differs according to the conditions of the units, and this must be taken into consideration when making matching impedance. The present invention is applicable to an antenna built-in type mobile radio apparatus in which an antenna is always built in a first unit or a second unit.

In the case of this example, it can be assumed that the antenna is not extended and remains contracted, and the matching is easier simply by detecting the condition of the units is opened or closed.

In the above structure, there are no condition changes in the antenna itself, and the antenna impedance can be considered to be almost constant or to show substantially no changes. Thus, matching of the antenna to other circuits is relatively easy with a minimum mismatching loss, and the antenna gain deterioration can be minimized.

Other modifications may be used without departing from the sprit of the present invention.

As explained above, the present invention provides a mobile radio apparatus capable of matching the impedance between an antenna and other circuits even if the antenna impedance changes depending on the changes in the condition between a first unit and a second unit.

The present invention also provides a mobile radio apparatus capable of matching the impedance between an antenna and other circuits even if the antenna impedance changes based on the detected condition of the antenna of the apparatus and the first and second units.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio apparatus comprising:
a first case unit, a second case unit, each of unit changes its position;
an antenna provided in any one of the first case unit or case second unit;
a case condition detecting unit configured to detect a condition between the first case unit and second case unit;
a matching unit configured to match between the antenna and a circuit; and
a switching unit configured to connect the matching unit to the antenna and other circuits based on the detected condition.

2. The mobile radio apparatus according to claim 1, wherein the first and second case units are slidable with each other.

3. The mobile ratio apparatus according to claim 1, wherein the first and second case units are constructed foldable.

4. The mobile radio apparatus according to claim 1,
an antenna condition detecting unit configured to detecting a condition of the antenna in the apparatus,
wherein the switching unit connects one of the matching unit to the antenna and the circuit based on the detected conditions of the case condition and antenna condition.

5. The mobile radio apparatus according to claim 4, wherein the switching unit includes a switch.

6. The mobile radio apparatus according to claim 5, wherein the switch is an element whose capacity is changed by application of voltage.

7. The mobile radio apparatus according to claim 6, wherein which further includes a strage unit for storing information about the voltage applied to the element.

8. The mobile radio apparatus according to claim 7, wherein the antenna has two or more resonance frequencies.

9. A mobile radio apparatus comprising:
a first case unit, a second case unit, each of unit changes its position;
an antenna provided in the first case unit or case second unit;
a case condition detecting unit configured to detect a condition between the first case unit and second case unit;
a matching unit connected to the antenna, capable of matching two or more impedances; and
a setting unit configured to set an impedance of the matching unit to one value based on the detected condition.

10. The mobile radio apparatus according to claim 9, wherein the setting unit controls the matching unit to meet the conditions of the antenna and the units by changing the capacitive component by the voltage applied to the predetermined element.
